(19) United States
(12) Patent Application Publication
(10) Pub. No.: US 2018/0274257 A1
(43) Pub. Date: Sep. 27, 2018

(54) SECTION OF CONCRETE COMPOSED OF SEVERAL PORTIONS FOR A MAST

(71) Applicant: HOLCIM TECHNOLOGY LTD., JONA (CH)

(72) Inventors: Svatopluk DOBRUSKY, SAINT QUENTIN FALLAVIER (FR); Jean-Nicolas RIVOAL, SAINT QUENTIN FALLAVIER (FR); Qing ZHANG, SAINT QUENTIN FALLAVIER (FR); Dominique CORVEZ, SAINT QUENTIN FALLAVIER (FR)

(21) Appl. No.: 15/763,994

(22) PCT Filed: Oct. 3, 2016
(86) PCT No.: PCT/EP2016/073536

§ 371 Date: Mar. 28, 2018

(30) Foreign Application Priority Data
Oct. 1, 2015 (FR) 1559363

(51) Int. Cl. E04H 12/12; E04H 12/34; F03D 13/20; E02D 27/42

(52) U.S. Cl. CPC E04H 12/12; E04H 12/341; E04H 12/085; E02D 27/425; F03D 13/20

(57) ABSTRACT

A section of concrete intended to form a mast for a windmill, the section extending along a longitudinal direction and including a first flange and a second flange, wherein the section is composed of several portions distributed along the longitudinal direction, the portions including a first portion with a first extremity and a second extremity opposed to each other in the longitudinal direction, the first portion including the first flange at its first extremity, the second extremity of the first portion is connected by a connecting interface to another portion continuing the first portion, and a second portion with a first extremity and a second extremity opposed to each other in the longitudinal direction, the second portion including the second flange at its second extremity.

### CONTEXT AND BACKGROUND OF THE INVENTION

The present invention relates to the technical field of superstructures.

More particularly, the subject of the present invention is a section of concrete intended to form a mast, notably for a windmill, a method for manufacturing the section of concrete, a mast of concrete comprising a set of sections comprising one or more of this section and a method to construct such a mast.

As the technology for producing electricity from wind energy has developed, it has been noted that there is a link between the power which can be delivered by the windmill and the dimensions of the windmill.

It is thus accepted that, in order to construct windmills capable of delivering high production powers, it is necessary to increase the length of the blades and therefore the height of the mast.

However, when increasing the height of a mast it is necessary to take into account a set of criteria which are connected on one hand to the desired technical performance of the mast, and on the other hand to the logistics of constructing the mast.

The technical performance criteria can comprise the load that has to be supported by the mast, and hence the compression resistance of the used materials, but also the tensile resistance of these materials.

Indeed, the tensile resistance is important as the loadings on the mast can cause significant tensile stresses.

The criteria linked to the logistics to be applied during the construction of the mast can, for their part, comprise the transportation of the various elements forming the mast from the production site where these elements are produced to the installation site, but also the conditions of assembling these elements on the installation site.

Together, these criteria have led to the production of masts made of concrete, to the detriment of steel, notably in order to facilitate transportation to the installation site and to reach higher heights.

As illustrated on FIG. 1, a mast 1, notably for a windmill 2, comprises a plurality of sections 10 of concrete stacked one on top of the other. Patent applications FR3029231 and no 1461729 describe such sections.

As illustrated in FIG. 2, a section 10 can be of a single piece or else, as illustrated in FIG. 3, a section 10 can comprise a plurality of segments 3. Then, such a section is a modular section 10.

In the example shown in FIG. 3, the modular section 10 comprises four segments 3a, 3b, 3c, 3d. These segments 3 can be assembled together by using means known to those skilled in the art, for example with vertical joints like those described in the document WO 2013/029743 A1.

The section 10 can be also of a single piece without segments 3.

In the example presented, the section 10 is in the form of a hollow cylinder defining an internal volume V of the section and an outer face E and an inner face I opposite the outer face E and arranged facing the internal volume V of the section 10.

The section 10 extends in a longitudinal direction and comprises:
a first flange 11′ extending substantially transversely from an inner face I of the section 10 in the internal volume V of the section 10, said first flange intended to exert a bearing force on a lower adjacent part of the windmill 2 in the longitudinal direction, such as another section 10; and
a second flange 12′ extending substantially transversely from the inner face I of the section 10 in the internal volume V of the section 10, said second flange intended to form a bearing support for another upper adjacent part of the windmill 2 in the longitudinal direction, such as another section 10.

A concrete section 10 is usually cast by pouring concrete in a formwork. However, due to the flanges, drawing the formwork can be difficult. Since the flanges 11′, 12′ protrude in the internal volume V, they prevent the internal part of the formwork from being withdrawn. Using a deformable or foldable formwork that would be more easily withdrawn might reduce the precision of the forms and dimensions of the section 10, whereas strict requirements must be met. Special formworks have to be designed because of these flanges.

In addition, different sections can have different lengths. As a result, a particular formwork is required for casting each section 10, even though said sections may have the same diameter. Because formworks are expensive, the length variety of the sections is restricted.

Furthermore, casting an entire section 10 requires a large amount of concrete being poured into the formwork. Facilities with limited space and equipment are therefore not able to produce such long sections. For instance, special equipment is required for storing, mixing and pumping such a large volume of concrete, especially because casting must be done within a limited time period.

In particular, mixing it can be challenging. Assuring the homogeneity of the concrete quality for such a large amount of concrete is very difficult. The quality of the concrete of the section 10 thus varies depending on the part of the section 10, which compromise the solidity and durability of the section 10.

In addition, the length of the section 10 in the longitudinal direction is usually of several metres, typically more than 5 m, more typically more than 10 m, and can be as long as 30 m. As a consequence, the section 10 is usually cast with its longitudinal direction being horizontal. Since the section 10 to be formed is a hollow cylinder, two distinct flows of concrete fill the formwork when concrete is poured into the formwork. When the concrete is reinforced with fibres, the fibres tend to be aligned in the direction of the filling of the formwork, perpendicular to the longitudinal direction. As a consequence, at the junction of the flows, there is a discontinuity in the fibres, which weakens the section.

### SUMMARY OF THE INVENTION

The present invention aims at resolving all or some of these drawbacks mentioned above. In particular, the invention proposes a section which is more resistant, more durable, easier and cheaper to manufacture.

To this end, it is proposed a section of concrete intended to form a mast for a windmill, said section extending along a longitudinal direction and comprising:
a first flange extending substantially transversely from an inner face of the section in the internal volume of the section, said first flange intended to exert a bearing force on a lower adjacent part of the windmill in the longitudinal direction,
a second flange extending substantially transversely from the inner face of the section in the internal volume of the section, said second flange intended to form a bearing support for another upper adjacent part of the windmill in the longitudinal direction,
   wherein the section is composed of several portions distributed along the longitudinal direction, said portions comprising at least:
a first portion with a first extremity and a second extremity opposed to each other in the longitudinal direction, said first portion comprising the first flange at its first extremity, the second extremity of the first portion is connected by a connecting interface to another portion, and
a second portion with a first extremity and a second extremity opposed to each other in the longitudinal direction, said second portion comprising the second flange at its second extremity.

Such a section can be more easily produced. Each portion can be cast separately. The require amount of concrete for each portion is less than for an entire section, which make it more easy to manage, improving the quality of the section. Since less equipment and space are required, more facilities are able to produce the section.

The casting of each portion is much easier that the casting of a section made of one single piece. Since no portion has two flanges, the formwork can be easily withdrawn. The design of the formwork can be simplified. In addition, first portions of the same dimensions can be used for sections of different lengths, which mean that a same formwork can be used.

Because each portion is necessarily shorter than a single piece section, casting a portion can be done with the longitudinal direction being vertical, enabling a better quality of the section, especially when the concrete comprises fibres.

Other preferred, although non limitative, aspects of the section are as follows, isolated or in a technically feasible combination:
the other portion is the second portion, the first extremity of the second portion connecting the second extremity of the first portion;
the other portion is an intermediate portion with a first extremity and a second extremity opposed to each other in the longitudinal direction, the first extremity of the intermediate portion connecting the second extremity of the first portion, and the first extremity of the second portion connecting the second extremity of the intermediate portion;
the length of the second portion along the longitudinal direction is less than the third of the total length of said section along the longitudinal direction;
the length of the first portion along the longitudinal direction is less than the third of the total length of said section along the longitudinal direction.

In one embodiment, the first portion comprises at its second extremity metal elements protruding in the longitudinal direction into the connecting interface, the other portion comprises at its first extremity metal elements extending in the longitudinal direction into the connecting interface, and the connecting interface comprises material burying said metal elements.

In another embodiment, a metal element extends in the longitudinal direction in the first portion and in the other portion through the connecting interface, a hole in the first section accommodating said metal element, said hole being filled with grouting material.

In another embodiment, the section comprises a metal connector on a face of the section said connector extending along the longitudinal direction on either side of the connecting interface, said metal connector being anchored to both the first portion and the other portion.

In another embodiment, he first portion comprises a first metal element embedded in said first portion, said first metal element reaching a surface of the first portion, the other portion comprises a second metal element embedded in said other portion, said second metal element reaching a surface of said other portion, the first metal element and the second metal element are welded to a common connector or are welded together at the connecting interface.

In another embodiment, the first portion comprises a first recess on a face of said section, said first recess extending along the longitudinal direction and reaching the second extremity of the first portion, the other portion comprises a second recess on the same face of said section, said second recess extending along the longitudinal direction and reaching the first extremity of said other portion, and a metal element is disposed in said first recess and in said second recess, said metal element being embedded in a burying material.

In another aspect, the invention relates to a windmill comprising a mast of concrete comprising a set of sections on top of the other comprising at least one section according to any possible embodiment of the invention.

The invention also relates to a method for manufacturing a section of concrete according to any possible embodiment of the invention, comprising the steps of:
casting separately the first portion and the other portion;
aligning along the longitudinal direction the second extremity of the first portion to the first extremity of the other portion,
connecting the second extremity of the first portion to the first extremity of the other portion by a connecting interface.

Preferably, at least for casting the first portion, concrete is poured into a formwork so as to form one of the extremities of said first portion before the other extremity of said first portion.

Preferably, at least for casting the first portion, concrete is poured into a formwork whose one side corresponding to an extremity of said first portion is open, an extremity of another portion being abutted on said side.

The invention also relates to a method to construct a mast of concrete intended for a windmill comprising the following steps:
having a set of sections available, said set of sections comprising at least one section according to any possible embodiment of the invention;
constructing the mast on an installation site by stacking all the sections of the set of sections one on top of the other.

### BRIEF DESCRIPTION OF THE DRAWINGS

Other aspects, objects and advantages of the present invention will become better apparent upon reading the following detailed description of preferred embodiments thereof, given as non-limiting examples, and made with reference to the appended drawings wherein:

FIG. 1, already discussed, shows an overview of a mast in situ for a windmill, and an exploded projection of the same mast into several sections;

FIG. 2, already discussed, shows an overview of a section of the mast illustrated in FIG. 1;

FIG. 3, already discussed, shows an overview of a variant of the section illustrated in FIG. 2;

FIG. 4 shows an overview of a section according to a possible embodiment of the invention;

FIG. 5 shows a cross-section of the section of FIG. 4;

FIGS. 6-11 show possible embodiment for the connection of two portions of the section of the mast.

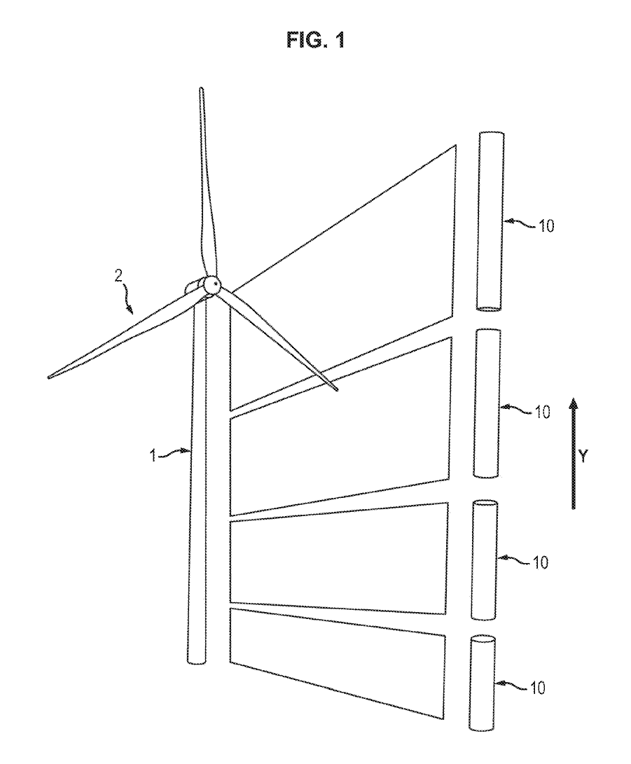

### DETAILED DESCRIPTION

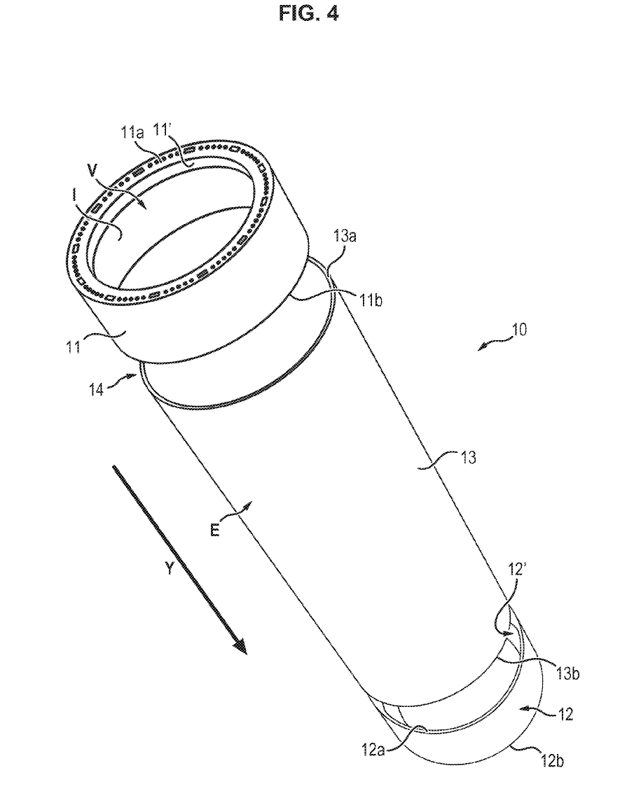

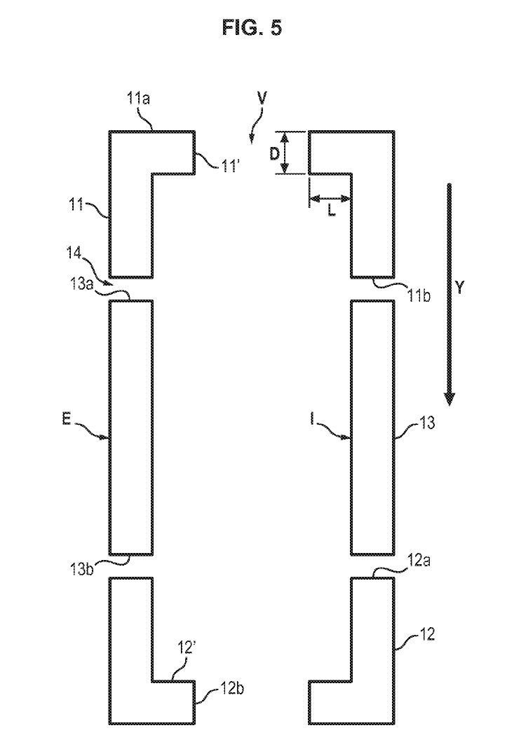

In reference to the example of FIG. 4, the section 10 is in the form of a hollow cylinder defining an internal volume V of the section and an outer face E and an inner face I opposite the outer face E and arranged facing the internal volume V of the section 10.

Advantageously, the section is made of ultra-high performance concrete or of ultra-high performance concrete reinforced by fibres.

Of course some ordinary reinforcement devices, as steel grids, could have been used.

This concrete can, for example, be of the type of that marketed by the company Lafarge under the trademark Ductal®.

The use of this type of concrete makes it possible to produce a lighter mast 1 than with a traditional concrete while retaining a reduced section diameter that notably allows for the transportation of sections presenting a length up to 40 m as one entire section from the production site to the installation site.

In particular, a section made of one entire concrete section, which can also be made of one-piece concrete section if it is not formed from a plurality of segments, can have an outer diameter that can range up to for example 4.40 m.

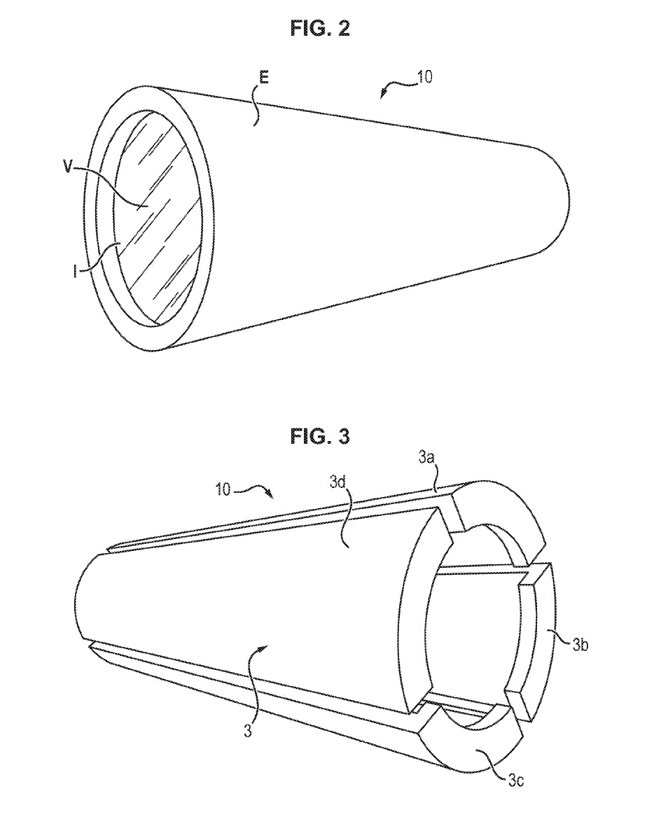

As the prior art section as illustrated on FIG. 2, the section 10 according to the invention extends in a longitudinal direction and comprises:
a first flange 11′ extending substantially transversely from an inner face I of the section 10 in the internal volume V of the section 10, said first flange intended to exert a bearing force on a lower adjacent part of the windmill 2 in the longitudinal direction; and
a second flange 12′ extending substantially transversely from the inner face I of the section 10 in the internal volume V of the section 10, said second flange intended to form a bearing support for another upper adjacent part of the windmill 2 in the longitudinal direction.

The considered parts of the windmill 2 can be a lower adjacent section 10 of the mast 1, an upper adjacent section 10 of the mast 1, but also a nacelle, a transition piece of the windmill 2 or the foundation structure of the mast 1.

In the example presented, the thickness d of the first flange 11′ and of the second flange 12′ is, for example, from 10 cm to 50 cm. The first flange 11′ and the second flange 12′ protrude from the inner face I of the section into the internal volume V over a distance of at least 10 cm. Obviously, the present invention is in no way limited to the form and the size of these flanges 11′, 12′.

In any case, the section 10 comprise a first extremity 10a where is arranged the first flange 11′ and a second extremity 10b where is arranged the second flange 12′.

Contrary to the prior art section as illustrated on FIG. 2, the section 10 comprise several portions 11, 12, 13 distributed along the longitudinal direction Y. A portion 11, 12, 13 may comprise a plurality of peripheral segments in a way similar to the section of figure. For the sake of simplicity, the following description is made in reference to single-piece portions without segments.

On the illustrated example, the section 10 comprises three portions:
a first portion 11,
an intermediate portion 13, and
a second portion 12.

Only two of these portions 11, 12, 13 comprise flanges: a so-called first portion 11 and a so-called second portion 12.

The first portion 11 has a first extremity 11a and a second extremity 11b opposed to each other in the longitudinal direction Y, said first portion 11 comprising the first flange 11′ at its first extremity. The first extremity 11a of the portion 11 constitutes the first extremity 10a of the section 10.

The second portion 12 has a first extremity 12a and a second extremity 12b opposed to each other in the longitudinal direction Y, said second portion 12 comprising the second flange 12′ at its second extremity 12b. The second extremity 11b of the portion 11 constitutes the second extremity 10b of the section 10.

At least another portion, other than the first portion 11 is connected to the second extremity 11b of the first portion 11 by a connecting interface 14. Said another portion continues the first portion 11.

In the illustrated example, the other portion is an intermediate portion 13 with a first extremity 13a and a second extremity 13b along the longitudinal direction Y, the first extremity 13a of the intermediate portion 13 connecting the second extremity 11b of the first portion 11, and the first extremity 12a of the second portion 12 connecting the second extremity 13b of the intermediate portion 13.

In the illustrated example, the intermediate portion 13 is made of one single piece of concrete. The intermediate portion 13 can also be constituted of several parts distributed along the longitudinal direction Y, each part of the intermediate portion 13 being connected to at least another part by a connecting interface.

The section 10 could also comprise only two portions, namely the first portion 11 and the second portion 12, each of them having one flange 11′, 12′. In this configuration, the other portion is the second portion 12 and the first extremity 12a of the second portion 12 connecting the second extremity 12b of the first portion 11.

In a preferred embodiment however, the section 10 comprises at least three portions 11, 12, 13. Preferably, the intermediate portion 13 is longer in the longitudinal direction than the first portion 11 and the second portion 12.

Advantageously, the length of the first portion 11 along the longitudinal direction is less than the third of the total length of said section 10 along the longitudinal direction, and more preferably less than the quarter or the fifth of the total length of said section 10.

Similarly, the length of the second portion 12 along the longitudinal direction is less than the third of the total length of said section 10 along the longitudinal direction and more preferably less than the quarter or the fifth of the total length of said section 10. For example, the length of the first portion 11 or of the second portion 12 in the longitudinal direction may be comprised between 1.5 m and 10 m, whereas the length of the intermediate portion 13 in the longitudinal direction may be comprised between 5 and 30 m.

The following description describes different exemplary embodiments for connecting the portions together. In a non-limiting way, the examples above are given for connecting the first portion 11 to another portion, namely the intermediate portion 13. It shall be understood however that the techniques can also be applied for connecting the second portion 12 directly to the first portion 11 or to the intermediate portion 13, or for connecting together different parts of the intermediate portion 13.

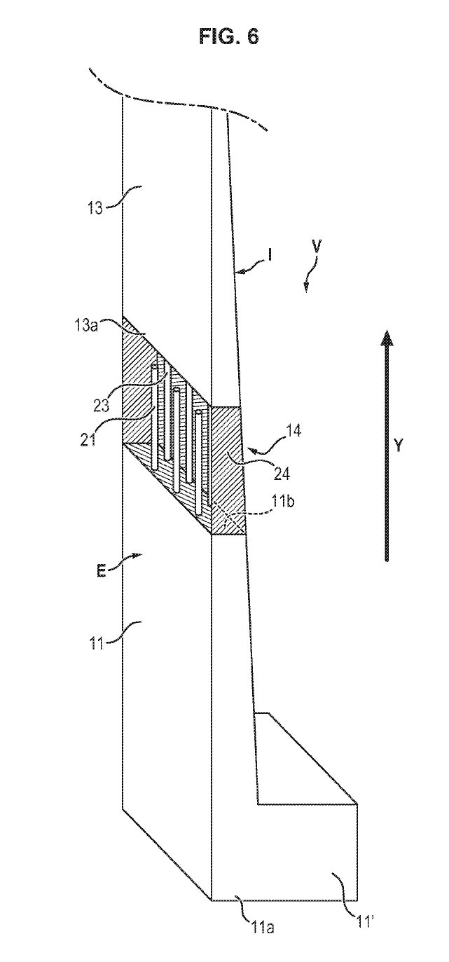

In reference to FIG. 6, the first portion 11 comprises at its second extremity 11b metal elements 21 protruding in the longitudinal direction into the connecting interface 14. The intermediate portion 13 also comprises at its first extremity 13a metal elements 23 extending in the longitudinal direction to the connecting interface 14, and the connecting interface 14 comprises material 24 burying said metal elements.

The material 24 burying the metal elements 21, 23 is preferably concrete, preferably of the same type as the concrete of the portions 11, 13. The metal elements 21, 23 are preferably steel bars, but may have other forms or may be made of another metal.

In the embodiment illustrated by FIG. 6, the metal elements 23 of the intermediate portion 13 protrude in the longitudinal direction in the connecting interface 14. Preferably, the metal elements 21, 23 protrude over more than 10 cm. The metal elements 23 of the intermediate portion 13 may also be fully embedded in said intermediate portion 13, and the protruding part of the metal elements 21 of the first portion 11 may then be buried in the intermediate portion 13.

The metal elements 21 of the first portion 11 may be interspersed with the metal elements 23 of the intermediate portion 13. The metal elements 21, 23 thus cross a same plane in the connecting interface 14 perpendicular to the longitudinal direction. In another embodiment, the metal elements 21 of the first portion 11 and the metal elements 23 of the intermediate portion 13 do not reach such a plane. There is a portion of the connecting interface 14 without both metal element 21 from the first portion 11 and metal elements 23 of the intermediate portion 13. In that case, additional metal elements may be provided, embedded in the material of the connecting interface 14 and extending in the longitudinal direction. In that case at least the metal elements 21 of the first portion 11 are interspersed with the metal elements embedded in the connecting interface 24. Preferably, the metal elements 23 of the intermediate portion 13 are also interspersed with metal elements embedded in the connecting interface 24, which may be the metal elements interspersed with the metal elements 21 of the first portion 11. The length, in the longitudinal direction, of the connecting interface can greatly vary depending on the embodiments, and for example may range from a few decimetres, e.g. more than 10 cm, up to several metres, e.g. up to 10 or 20 metres.

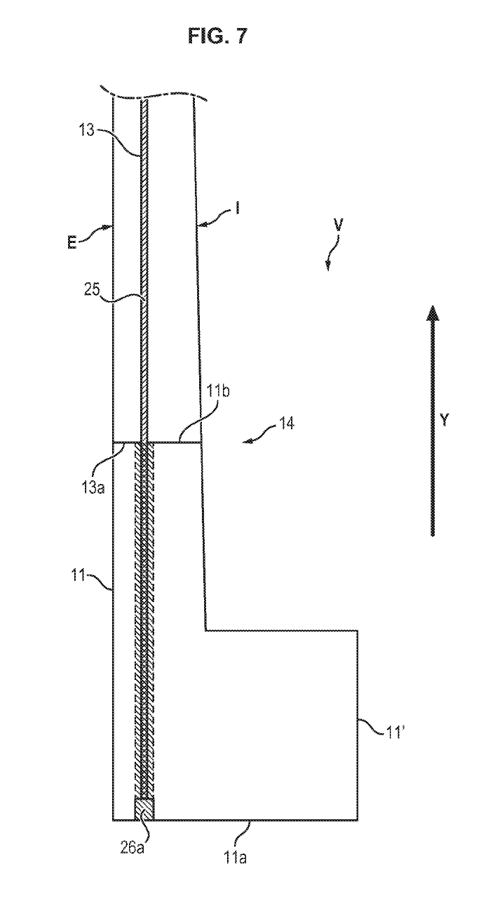

In another embodiment illustrated by FIG. 7, at least one metal element 25 extends in the longitudinal direction in the first portion 11 and in the other portion 13 through the connecting interface 14. A hole 26 extending at least in the first portion 11 accommodates said metal element 25, said hole 26 being filled with grouting material.

For connecting these portions, the second extremity 11b of the first portion 11 is abutted to the first extremity 13a of the intermediate portion 13. The metal element 25 can protrude from the intermediate portion 13 into the hole 26 of the first portion 11, or can be inserted into the hole 26 to reach the intermediate portion 13. Preferably, the hole 26 is open at the first extremity 11a of the first portion 11. The hole 26 is then filled up by a grouting material.

The metal element 25 is preferably a steel bar, but may have other forms or may be made of another metal. Typically, several metal elements 25 are distributed over the connecting interface 14, for example regularly disposed over the whole circumference of said connecting interface 14.

To realise this kind of connection, the second extremity 11b of the first portion 11 is aligned with the first extremity 13a of the intermediate portion 13. If required, for example if the metal elements are not interspersed, additional metal elements are provided in the region intended for the connecting interface 14. Material is then poured into a formwork surrounding said region, burying the metal elements.

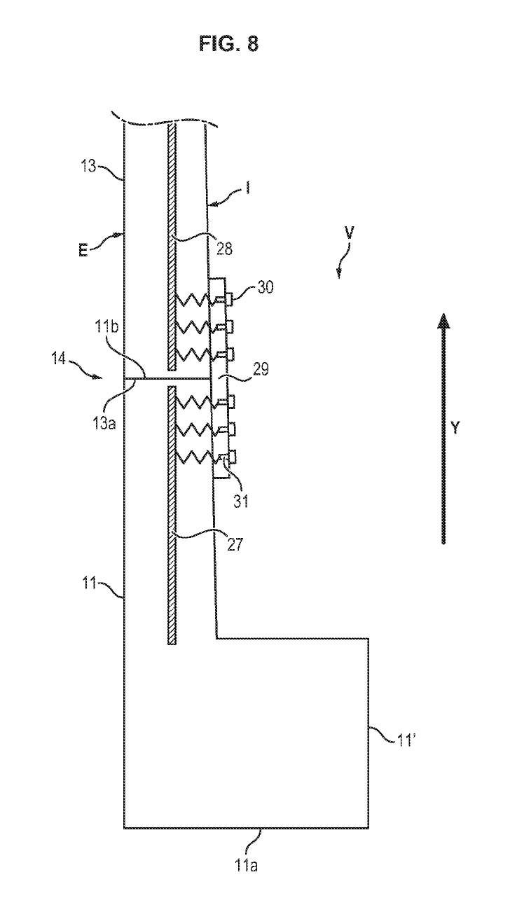

In another embodiment illustrated by FIG. 8, the section 10 comprises a metal connector 29 on a face of the section 10, said connector 29 extending along the longitudinal direction on either side of the connecting interface 14, said metal connector 29 being anchored to both the first portion 11 and the intermediate portion 13.

In the example of FIG. 8, the connector 29 is disposed on the inner face I of the section 10, i.e. in the internal volume V of said section 10. The connector 29 may have the same shape as said inner face I. The connector 29 is preferably made of metal such as steel.

The anchorage of the connector 29 on the portions 11, 13 can be a mechanical anchorage or a chemical anchorage, e.g. chemical fastening or bonding. The connector 29 can be bonded in place with chemical compounds such as epoxies, polyesters or vinylesters. Chemical anchorage can also be done for example with an anchoring device secured into a hole filled with a chemical substance, or with fasteners that can be either surface mounted or injection anchors using a variety of adhesives or epoxies.

In FIG. 8, the connector 29 is anchored to the portions 11, 13 by at least one first fixing organ 30 connecting said connector 29 to the first portion 11 and by at least one second fixing organ 31 connecting said connector 29 to the intermediate portion 13. The first fixing organ 30 and/or the second fixing organ 31 may be bolts and nuts, nails, or a layer of glue. For example for bolts and nuts, the bolts are embedded in the concrete of the portions 11, 13 when said portions are cast.

In order to reinforce the connection, as illustrated by FIG. 8, the first portion 11 may comprise at least one first metal element 27 embedded in said first portion 11, and the intermediate portion 13 may comprise at least one second metal element 28 embedded in said other portion 13. At least a part of each one of said metal elements faces the connector 29.

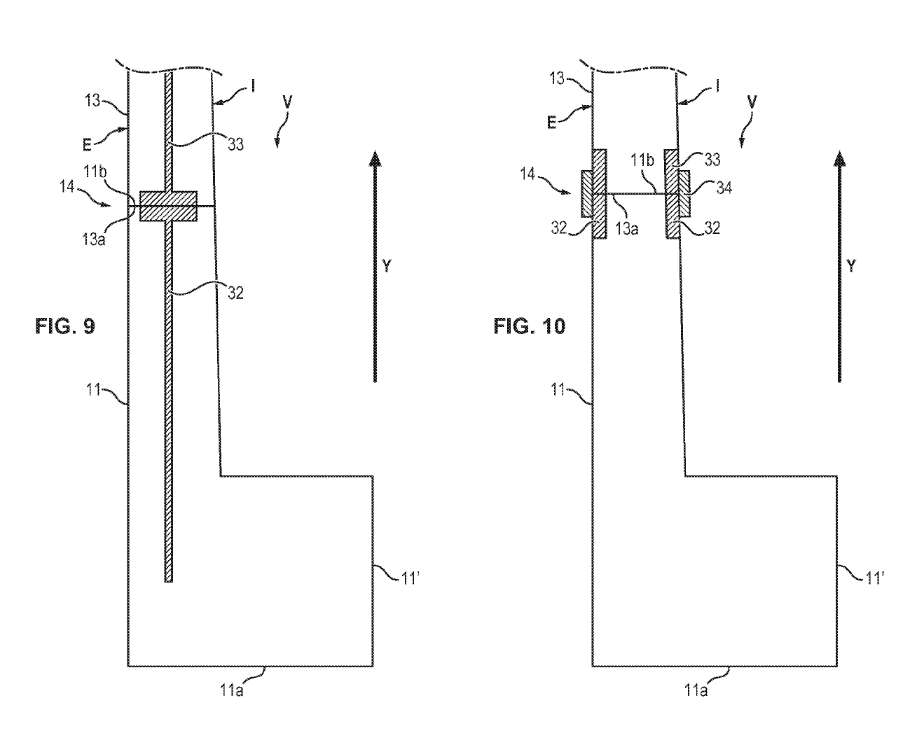

In other embodiments illustrated by FIGS. 9 and 10, the first portion 11 comprises a first metal element 32 embedded in said first portion 11, said first metal element 32 reaching a surface of the first portion 11, and the intermediate portion 13 comprises a second metal element 33 embedded in said other portion 13, said second metal element 33 reaching a surface of said intermediate portion 13. The surfaces reached by the embedded metal elements 32, 33 may be on the inner face I and/or the outer face E, as in FIG. 10, and/or on the extremities 11b, 13a of the connected portions 11, 13.

For example, the first metal element 32 reaches the second extremity 11b of the first portion 11, and the second metal element 33 reaches the second extremity 13a of the intermediate portion 13.

At the connecting interface 14, the first metal element 32 and the second metal element 33 may be welded together, as in FIG. 9, or may be welded to a common metal connector 34 as in FIG. 10. The common metal connector 34 extends on either side of the connecting interface 14, and faces the surfaces reached by the metal elements 32, 33. As in FIG. 10, a common metal connector 34 may be disposed on each of the outer face E of the section 10 and of the inner face I of the section 10. The common metal connector 34 may however be disposed on one face only, preferably the inner face I. A common metal connector 34 disposed on the inner face I is more protected and therefore enjoys a better durability.

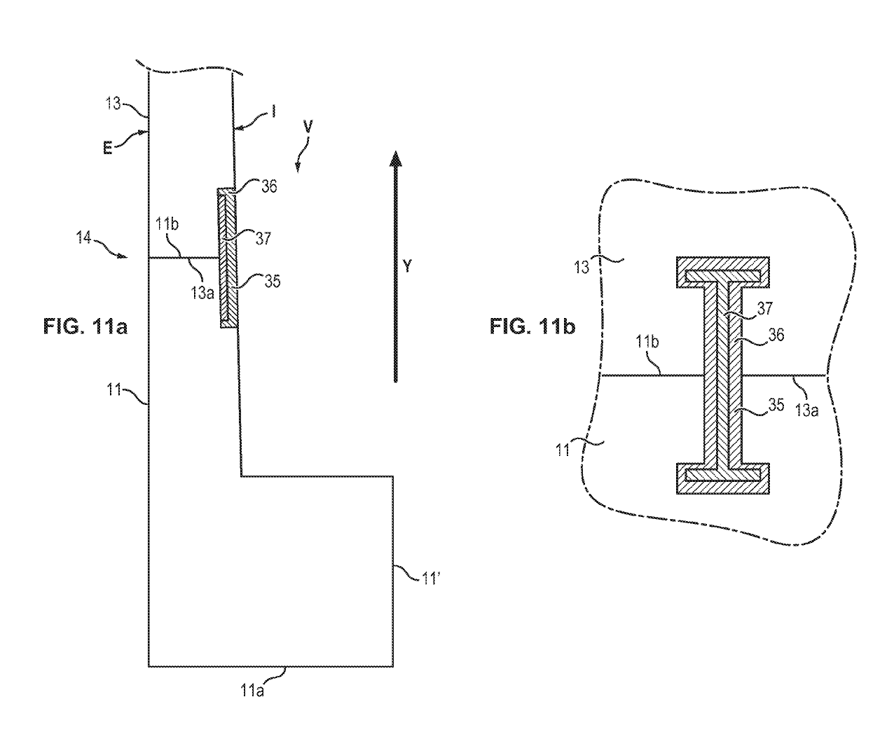

Another embodiment is illustrated by FIGS. 11a and 11b. FIG. 11a shows a partial view of a cross-section of the connecting interface 14 between the first portion 11 and the intermediate portion 13, while FIG. 11b shows an enlarged front view of the connecting interface 14 of FIG. 11a.

The first portion 11 comprises a first recess 35 on a face E, I of the section 10, said first recess 35 extending along the longitudinal direction Y and reaching the second extremity 11b of the first portion 11. The intermediate portion 13 comprises a second recess 36 on the same face E, I of the section 10, said second recess 36 extending along the longitudinal direction and reaching the first extremity 13a of said other portion 13. A metal element 37 is disposed in said first recess 35 and said second recess 36, said metal element 37 being embedded in a burying material. The burying material is typically concrete.

Preferably, the recesses 35, 36 are arranged on the inner face I of the section 10, i.e. open to the internal volume V, in order for the metal element 37 to have a better weather protection and better accessibility. Preferably, the first recess 35 is open to the second extremity 11b of the first portion 11, the second recess 36 is open to the first extremity 13a of the intermediate portion 13, and their respective opening in said extremities are aligned with each other, so that the metal element 37 can cross the connecting interface 14 without being exposed.

The recess can be arranged when the portions 11, 13 are cast, or can be later dug inside said portions 11, 13. The metal element 37 is disposed in the recesses 35, 36, and then buried in the burying material. The metal element 37 is preferably made of steel. As for the other possible embodiment, several metal elements 37 are typically distributed over the connecting interface 14, for example regularly disposed over the whole circumference of said connecting interface 14.

The section according to the invention is much easier to produce. The portions 11, 12, 13 are cast separately. Because each portion 11, 12, 13 is necessarily shorter than a single piece section 10, the casting of the section 10 by portions is much easier.

In particular, match-casting can be employed. Once a portion 11, 12, 13 is made, the extremity of said portion intended to be connected to the next portion to be made can form a side of the formwork used for said next portion. For example, once the first portion 11 is cast, the second extremity 11b of said first portion 11 can be abutted to an open side of a formwork, said open side corresponding to the first extremity of an adjacent portion to be made, for instance the first extremity 13a of the intermediate portion 13.

Adhesion between the different portions during match-casting may be prevented through various known means, such as a plastic film or by a provisional coating.

Matched extremities of portions allow for a perfect connection between said portions, with a joint of minimum thickness. In addition, the alignment of the portions once erected can be assured by the alignment between the already cast portion and the formwork of the portion to cast.

Match-casting may also be used for matching adjacent portions of two different sections. For example, the first extremity 11a of a first portion 11 of a section 10 may be matched with the second extremity 12b of a second portion 12 of another section 10 intended to be an adjacent lower part of the windmill 2.

Due to the shorter length of the portions 11, 12, 13 with respect to total length of the section 10, casting a portion can be done with the longitudinal direction being vertical.

Concrete is poured into the formwork forms one of the extremity of said portion before the other extremity. For example, at least for casting the first portion 11, concrete is poured into a formwork so as to form one of the extremities 11a, 11b of said first portion 11 before the other extremity 11a, 11b of said first portion 11.

Since there is only one flow of concrete filling up the formwork, the weakness at the junction of the flows is eliminated. In addition, the fibres tend to be aligned in the longitudinal direction.

For manufacturing a section of concrete, after the portions 11, 12, 13 are cast, the second extremity 11b of the first portion 11 is aligned in the longitudinal direction with the first extremity 12a, 13a of the other portion 12, 13, and the second extremity 11b of the first portion is connected to the first extremity 12a, 13a of the other portion by a connecting interface 14, as described before. The same method may be used for every portion.

Once the sections of concrete are fabricated, a mast 1 of concrete intended for a windmill 2 can be constructed. The method comprises the following steps:
having a set of sections available, said set of sections comprising at least one section 10 according to any embodiment;
constructing the mast 1 on an installation site by stacking all the sections of the set of sections one on top of the other.

It is then possible to obtain a windmill comprising a mast 1 of concrete comprising a set of sections on top of the other comprising at least one section 10 according to any possible embodiment.

While the present invention has been described with respect to certain preferred embodiments, it is obvious that it is in no way limited thereto and it comprises all the technical equivalents of the means described and their combinations. In particular, it will be apparent to those skilled in the art that various changes and modifications may be made without departing from the scope of the invention as defined in the appended claims.

1. A section of concrete intended to form a mast for a windmill, said section extending along a longitudinal direction and comprising:
a first flange extending substantially transversely from an inner face of the section in an internal volume of the section, said first flange intended to exert a bearing force on a lower adjacent part of the windmill in the longitudinal direction,
a second flange extending substantially transversely from the inner face of the section in the internal volume of the section, said second flange intended to form a bearing support for another upper adjacent part of the windmill in the longitudinal direction,
wherein the section is composed of several portions distributed along the longitudinal direction, said portions comprising at least:
a first portion with a first extremity and a second extremity opposed to each other in the longitudinal direction, said first portion comprising the first flange at its first extremity, the second extremity of the first portion is connected by a connecting interface to another portion, and
a second portion with a first extremity and a second extremity opposed to each other in the longitudinal direction, said second portion comprising the second flange at its second extremity.

2. The section according to claim 1, wherein the other portion is the second portion, the first extremity of the second portion connecting the second extremity of the first portion.

3. The section according to claim 1, wherein the other portion is an intermediate portion with a first extremity and a second extremity opposed to each other in the longitudinal direction, the first extremity of the intermediate portion connecting the second extremity of the first portion, and the first extremity of the second portion connecting the second extremity of the intermediate portion.

4. The section according to claim 3, wherein the length of the second portion along the longitudinal direction is less than the third of the total length of said section along the longitudinal direction.

5. The section according to claim 1, wherein the length of the first portion along the longitudinal direction is less than the third of the total length of said section along the longitudinal direction.

6. The section according to claim 1, wherein
the first portion comprises at its second extremity metal elements protruding in the longitudinal direction into the connecting interface,
the other portion comprises at its first extremity metal elements extending in the longitudinal direction into the connecting interface,
wherein the connecting interface comprises material burying said metal elements.

7. The section according to claim 1, wherein a metal element extends in the longitudinal direction in the first portion and in the other portion through the connecting interface, a hole in the first section accommodating said metal element, said hole being filled with grouting material.

8. The section according to claim 1, wherein the section comprises a metal connector on a face of the section said connector extending along the longitudinal direction on either side of the connecting interface said metal connector being anchored to both the first portion and the other portion.

9. The section according to claim 1, wherein:
the first portion comprises a first metal element embedded in said first portion, said first metal element reaching a surface of the first portion,
the other portion comprises a second metal element embedded in said other portion, said second metal element reaching a surface of said other portion,
wherein the first metal element and the second metal element are welded to a common connector or are welded together at the connecting interface.

10. The section according to claim 1, wherein
the first portion comprises a first recess on a face of said section, said first recess extending along the longitudinal direction and reaching the second extremity of the first portion,
the other portion comprises a second recess on the same face of said section, said second recess extending along the longitudinal direction and reaching the first extremity of said other portion,
wherein a metal element is disposed in said first recess and in said second recess, said metal element being embedded in a burying material.

11. A windmill comprising a mast of concrete comprising a set of sections on top of the other comprising at least one section according to claim 1.

12. A method for manufacturing a section of concrete according to claim 1, comprising:
casting separately the first portion and the other portion;
aligning along the longitudinal direction the second extremity of the first portion to the first extremity of the other portion,
connecting the second extremity of the first portion to the first extremity of the other portion by a connecting interface.

13. The method according to claim 12, wherein at least for casting the first portion, concrete is poured into a formwork so as to form one of the extremities of said first portion before the other extremity of said first portion.

14. The method according to claim 12, wherein at least for casting the first portion, concrete is poured into a formwork whose one side corresponding to an extremity of said first portion is open, an extremity of another portion being abutted on said side.

15. A method to construct a mast of concrete intended for a windmill comprising:
having a set of sections available, said set of sections comprising at least one section according to claim 1;
constructing the mast on an installation site by stacking all the sections of the set of sections one on top of the other.
